(19) United States
(12) Patent Application Publication
(10) Pub. No.: US 2004/0157484 A1
(43) Pub. Date: Aug. 12, 2004

(54) Wire connector

(76) Inventor: Keith Louzon, Portland, OR (US)

Correspondence Address: SMITH-HILL AND BEDELL, 12670 N W BARNES ROAD, SUITE 104, PORTLAND, OR, 97229

(21) Appl. No.: 10/361,105

(22) Filed: Feb. 7, 2003

(51) Int. Cl. H01R 4/24

(52) U.S. Cl. 439/393

(57) ABSTRACT

A connector for attachment to a wire includes a body that is made of electrically insulating material and defines a passage for receiving an end segment of the wire. The electrically insulating body has a first attachment structure at a first side region and a second attachment structure at a second side region. The first and second attachment structures are at least partially complementary. An electrically conductive interconnection element has first and second edge portions exposed at the first and second side regions respectively and has a medial portion exposed in the passage. The medial portion of the interconnection element is shaped and configured to enter electrically conductive contact with an end segment of a wire that is inserted in the passage and the first and second portions of the interconnection element are at least partially complementary. When end segments of first and second wires are inserted in the passages of first and second connectors respectively, the first and second wires enter electrically conductive contact with the medial portions of the interconnection elements of the first and second connectors respectively, and when the first attachment structure of the first connector is engaged with the second attachment structure of the second connector, the bodies of the first and second connectors are attached together and the first edge portion of the interconnection element of the first connector and the second edge portion of the interconnection element of the second connector are electrically connected.

### BACKGROUND OF THE INVENTION

This invention relates to a wire connector.

The standard device for connecting wires in a domestic electric power distribution wiring system is the wire nut. Two (or more) wires, each comprising a metal core and an insulating sleeve, are stripped at the ends that are to be connected to expose end segments of the metal core and the exposed end segments are inserted into the wire nut and the wire nut is twisted onto the ends of the wires. In this manner, the stripped end segments of the cores are twisted around each other and held in firm, electrically conductive, contact.

The wire nut is applied by hand, and in a typical installation an electrician might have to apply 100 or more wire nuts. Application of a wire nut requires a substantial manual effort and the repeated twisting motion involved in applying wire nuts may induce repetitive stress injury.

### SUMMARY OF THE INVENTION

According to the present invention there is provided a connector for attachment to a wire having a conductive core and an insulating sleeve, the connector comprising a body of electrically insulating material, the body defining a passage for receiving an end segment of the wire and having a first attachment structure at a first side region and a second attachment structure at a second side region, the first and second attachment structures being at least partially complementary, and an electrically conductive interconnection element having first and second portions exposed at the first and second side regions respectively and having a third portion exposed in the passage, the third portion of the interconnection element being shaped and configured to enter electrically conductive contact with an end segment of a wire that is inserted in the passage and the first and second portions of the interconnection element being at least partially complementary, whereby when end segments of first and second wires are inserted in the passages of first and second connectors respectively, the first and second wires enter electrically conductive contact with the third portions of the interconnection elements of the first and second connectors respectively, and when the first attachment structure of the first connector is engaged with the second attachment structure of the second connector, the bodies of the first and second connectors are attached together and the first portion of the interconnection element of the first connector and the second portion of the interconnection element of the second connector are electrically connected.

### BRIEF DESCRIPTION OF THE DRAWINGS

For a better understanding of the invention, and to show how the same may be carried into effect, reference will now be made, by way of example, to the accompanying drawings, in which

FIG. 1 is a perspective view of a first wire connector embodying the present invention,

FIG. 2 is a sectional view of the wire connector,

FIG. 3 is a sectional view taken on the line 3-3 of FIG. 2,

FIG. 4 is a sectional view taken on the line 4-4 of FIG. 2, and

FIG. 5 illustrates three wire connectors that are interconnected as a strip of connectors.

### DETAILED DESCRIPTION

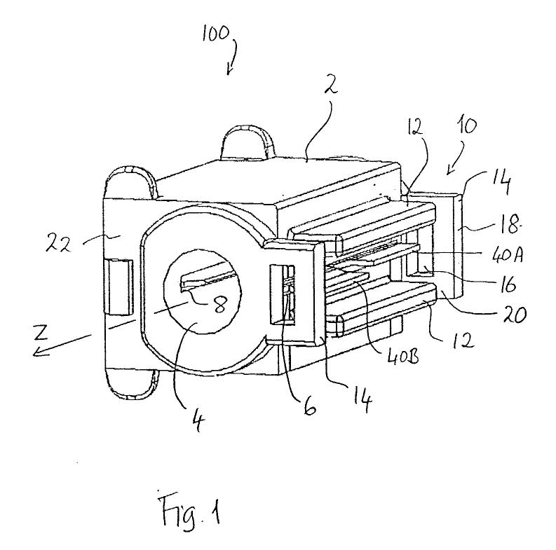

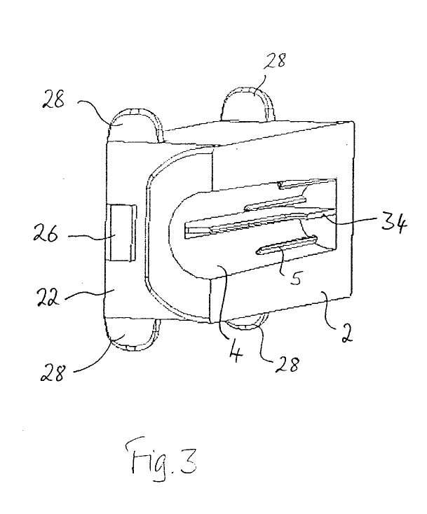

The connector 100 that is shown in FIGS. 1-3 comprises an injection molded body 2 of insulating synthetic polymer material. The body 2 defines a longitudinal passage 4 having a central axis Z. The passage 4 is circular in cross-section and tapers slightly from its open and towards its opposite closed end. The passage 4 is dimensioned to receive an unstripped end of a solid core wire for domestic use when connected to a 110 volt supply. The external diameter of such wire is typically about 2-5 mm and the diameter of the core, which is usually copper or aluminum, is 1-4 mm. The interior surface of the passage is provided with ribs 5.

The body defines two slot-form passages 6, 8. The slot-form passages 6, 8 extend perpendicular to the axis Z and open to opposite respective sides of the body 2. The passage 6 opens at the base or bottom of a recess bounded by a shroud 10. The shroud 10 has longitudinal walls 12 and transverse walls 14. The transverse walls 14 are each formed with a rectangular opening 16 bounded by a bail 18. Each longitudinal wall 12 is separated from the transverse walls 14 by slots 20.

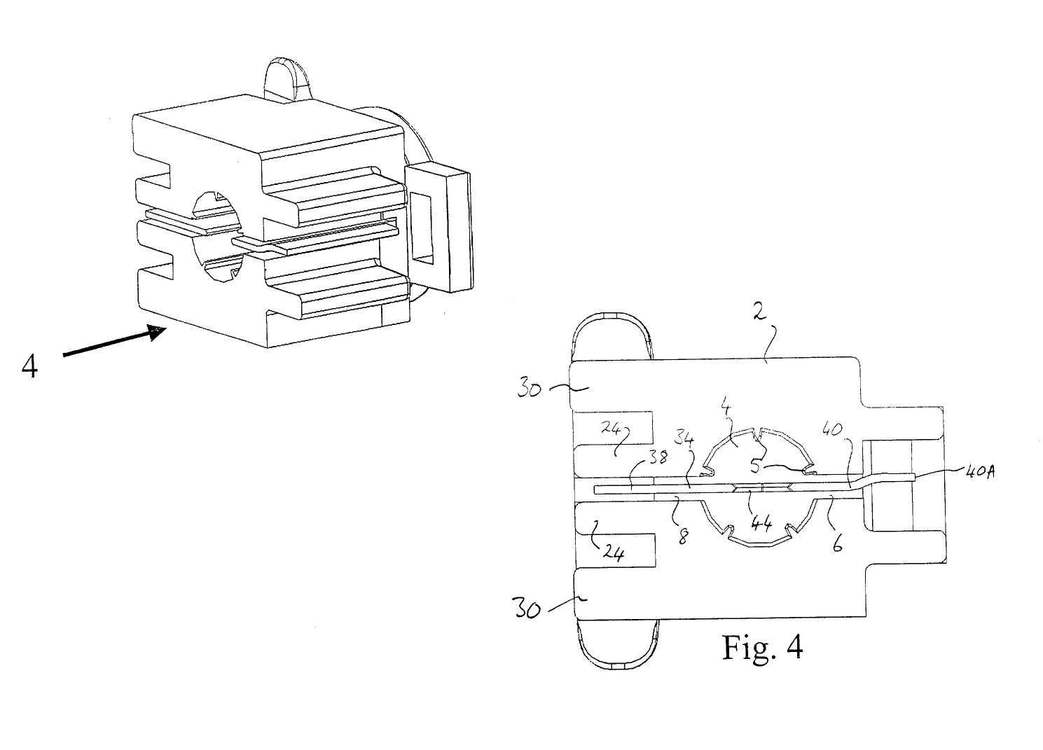

The passage 8 opens at the base of a recess between two transverse walls 22 and two longitudinal walls 24. The walls 22, 24 are at the opposite side of the body from the walls 12, 14. Each of the transverse walls 22 includes a rectangular latch element 26 and two tabs 28. Referring to FIG. 4, the longitudinal walls 24 are located between two outer longitudinal walls 30. Each transverse wall 22 is separated from the longitudinal walls 24, 30 by slots 31, so that the free ends of the transverse walls can be deflected together slightly by manual pressure applied to the tabs 28.

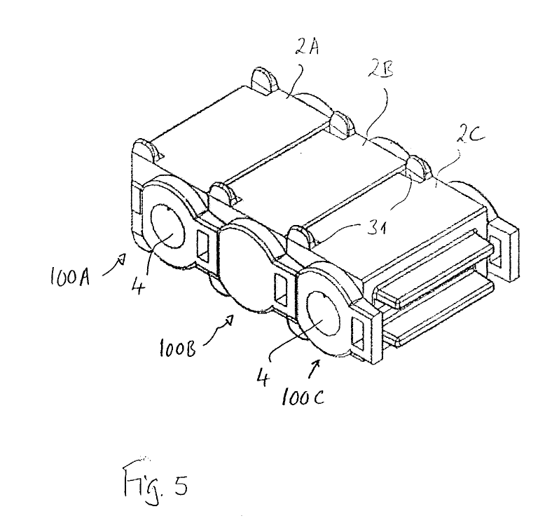

The two sides of the body are configured in complementary fashion so that the bodies 2A and 2B of two identical connectors 100A and 100B (FIG. 5) can be interlocked by squeezing the transverse walls 22 of the body 2B together and pushing the walls 22 into the slots 20 of the body 2A. When the walls 22 of the body 2B are progressively received in the slots 20 of the body 2A, the latch elements 26 of the body 2B pass the bails 18 of the body 2A and spring back into the openings 16 of the body 103 when the deflecting force is released. In the interlocked state, the longitudinal walls 24 of the body 2A are located between the longitudinal walls 12 of the body 2B. In this manner, the two plastic bodies 2A and 2B are firmly attached to each other. The two bodies can be detached by squeezing the tabs 28 of the body 2B together and thereby deflecting the transverse walls 22 so that the latch elements 26 of the body 2B are withdrawn from the openings 16 and clear the bails 18 of the body 2A.

Each connector also comprises a bracket or blade 34 of metal captive in the body 2. The body 2 is molded about the bracket in a multicavity mold so that the bracket, which is located in the slots 6, 8, is captive in the body 2 and is movable slightly relative to the body 2

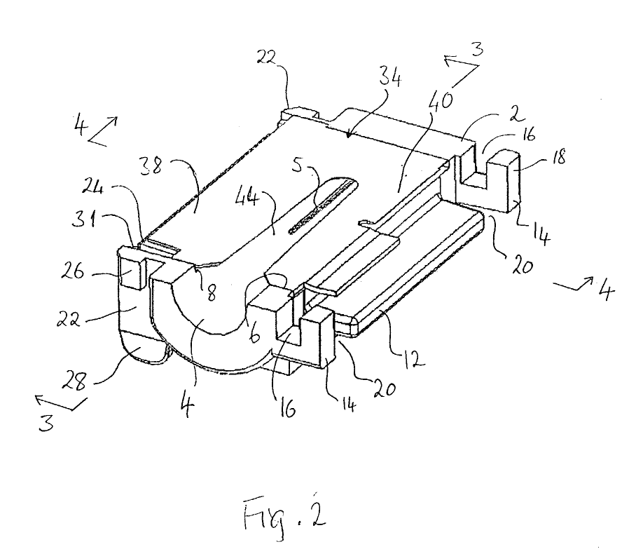

Referring to FIG. 2, the bracket 34 is generally rectangular in plan view and has two edge regions 38, 40 that project through the slots 8 and 6 respectively, separated by a medial region that is located in the longitudinal passage 4 and contains a U-shaped recess 44 that is aligned with the central axis Z of the longitudinal passage 4. The straight edges of the bracket 34 bounding the U-shaped recess 44 are V-shaped in section when viewed along the axis Z and converge slightly in the direction from the open end of the passage 4 towards the closed end thereof. The edge region 38 is generally planar whereas the edge region 40 is composed of a portion 40A that is deflected slightly upwards relative to the medial region, as seen in FIG. 1, and a portion 40B that is deflected slightly downwards relative to the medial region. When the two bodies 2A, 2B are interlocked, as described above, the edge region 38 of one bracket is inserted between the upwardly and downwardly deflected portions 40A, 40B of the edge region 40 of the other bracket and the two brackets are then in firm electrically conductive pressure contact.

In operation, a user places the unstripped end of a wire in the entrance of the longitudinal passage 4 and then firmly pushes the end of the wire into the passageway. As the tip of the wire enters the passageway, the leading edge of the insulating sleeve comes into contact with the bracket 34, and the V-shaped configuration of the edges of the bracket cuts into the insulating sleeve and splits the insulating sleeve longitudinally as the wire is forced further into the longitudinal passage. As the tip of the wire approaches the point at which the width of the U-shaped recess in the bracket is equal to the diameter of the core, the two sides of the recess enter into contact with the core. Since the metal core is malleable, the core is deformed as the wire is forced into the cylindrical passage and a firm, electrically conductive pressure contact is created between the core and the bracket. The ribs 5 deform the leading edge of the insulating sleeve as the wire is forced into the passage, and frictional engagement of the ribs with the sleeve resists removal of the connector from the end of the wire. In this manner, the wire is provided with a connector and the bracket of the connector is electrically connected to the core of the wire.

In similar fashion, the user applies a connector to the end of another wire, and the user then interlocks the two connectors in the manner described above. When the two connectors are interlocked, the two wires are electrically connected through the brackets of the respective connectors. It will, or course, be appreciated that additional connectors may be secured to the two connectors 100A and 100B, so that an arbitrary number of wires can be interconnected by a strip of connectors 100 as shown in FIG. 5. It will also be appreciated that the connections are made without need for any repetitive twisting motion. Since the interlocking structures are symmetrical, two interlocked connectors can be oriented with the passages 4 open at opposite sides of the strip.

The connector may be designed to fit a single wire size, but it is preferred that the taper of the passage 4 and the spacing between, and convergence of, the edges of the U-shaped recess in the bracket be selected so that a given connector can be applied to wires of at least two different sizes.

Although use of the connector has been described with reference to unassisted manual insertion of the end of the wire into the cylindrical passage of the connector body, it will be appreciated that the effort required to engage the connector with the end of the wire may be reduced by use of a suitable tool for gripping the wire and forcing the connector onto the end of the wire.

It will be appreciated that the invention is not restricted to the particular embodiment that has been described, and that variations may be made therein without departing from the scope of the invention as defined in the appended claims and equivalents thereof. For example, by suitably designing the bracket, it would be possible to have the bracket strip the insulating sleeve from the end of the core instead of splitting the sleeve and otherwise leaving the sleeve in tact. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A connector for attachment to a wire having a conductive core and an insulating sleeve, the connector comprising:
a body of electrically insulating material, the body defining a passage for receiving an end segment of the wire and having a first attachment structure at a first side region and a second attachment structure at a second side region, the first and second attachment structures being at least partially complementary, and
an electrically conductive interconnection element having first and second portions exposed at the first and second side regions respectively and having a third portion exposed in the passage, the third portion of the interconnection element being shaped and configured to enter electrically conductive contact with an end segment of a wire that is inserted in the passage and the first and second portions of the interconnection element being at least partially complementary,
whereby when end segments of first and second wires are inserted in the passages of first and second connectors respectively, the first and second wires enter electrically conductive contact with the third portions of the interconnection elements of the first and second connectors respectively, and when the first attachment structure of the first connector is engaged with the second attachment structure of the second connector, the bodies of the first and second connectors are attached together and the first portion of the interconnection element of the first connector and the second portion of the interconnection element of the second connector are electrically connected.

2. A connector according to claim 1, wherein the body has six side regions and is substantially parallelepipedal in configuration, the first side region of the body is opposite the second side region of the body, and the passage enters the body at a third side region.

3. A connector according to claim 2, wherein the passage is substantially circular in cross section and the interconnection element extends diametrally of the passage.

4. A connector according to claim 3, wherein the interconnection element has a U-shaped recess for receiving the core of the wire.

5. A connector according to claim 4, wherein the interconnection element is configured at edges of the U-shaped recess to cut the insulating sleeve of the wire and engage the conductive core.

6. A connector according to claim 1, wherein the first attachment structure includes a deflectable latch element and the second attachment structure includes a retainer element that is substantially complementary to the deflectable latch element.
